(19) United States
(12) Patent Application Publication
(10) Pub. No.: US 2008/0013120 A1
(43) Pub. Date: Jan. 17, 2008

(54) Method for automatically adjusting the position and size of each object of an image mask to fit an image page

(75) Inventor: Hai-Hang Ying, Hangzhou City (CN)

Correspondence Address: BACON & THOMAS, PLLC, 625 SLATERS LANE, FOURTH FLOOR, ALEXANDRIA, VA, 22314, US

(73) Assignee: ArcSoft, Inc., Fremont, CA (US)

(21) Appl. No.: 11/484,635

(22) Filed: Jul. 12, 2006

(51) Int. Cl. G06K 15/00

(52) U.S. Cl. 358/1.12; 358/1.18

(57) ABSTRACT

The present invention discloses a method for automatically adjusting the position and size of each object of an image mask to fit an image page, and the method is applied to an image mask. The image mask includes an object such as a frame, a figure and a text, and each object can change its position and dimensions on the image mask according to a predetermined variable or invariable attribute and a relative position attribute or absolute position attribute to automatically adjust its position and dimensions on the image mask to adapt the change of the image page, such that after the image mask is adjusted, the position and dimensions of each object still can meet a designer's expected design style and artistic visual effect.

### FIELD OF THE INVENTION

The present invention relates to a method for adjusting an object of an image mask, and more particularly to a method for automatically adjusting the position and size of each object of an image mask to fit an image page still meeting with the designer's expected design style and artistic visual effect.

### BACKGROUND OF THE INVENTION

In recent years, digital image capturing technology is changing day after day, and various different electronic devices (such as a digital camera, a digital camcorder, a notebook computer and a mobile phone, etc) that install digital image capturing components are developed and introduced to the market constantly, and this trend not only enhances the quality of image capturing and reduces the size of the product, but also lowers the price of the product. Therefore, these electronic devices become popular in the market.

In view of the popularity of the electronic devices that install digital image capturing components, the extensive consumers have increasingly high requirements for digital image application software. Referring to FIG. 1 for a present popular image mask application software, the image mask application software includes a plurality of built-in image masks 10, and each image mask 10 is designed according to different design subject matters including different cultures, scenes, festivals, memorial days, and atmospheres by professional designers and having a template with different objects including a figure 11, a text 12 and a frame 13. In an image mask 10 which is designed for Christmas or New Year as shown in FIG. 1, designers create a frame 13 according to a special festival, and the frame 13 has a rectangular hollow window 131 with circular arc corners, and the figure 11 for decorating the frame 13 is a flower for celebrating the festival, and the text 12 “A HAPPY NEW YEAR” is a seasonal greeting for Christmas (or New Year) displayed on the left side of the bottom at the middle of the frame 13, and the icons of the image mask 10 are displayed on the screen of the electronic device for users to click or select. By the processing of the application software, the frame 13 can be attached onto a processing image 20 to produce a composite image 20 as shown in FIG. 2 after the manufacture processing is completed. In general, the application software will automatically change the dimensions and proportion of the image mask 10 according to the processing page size of the image 20 (such as 5 inches wide and 3 inches high, 4 inches wide and 6 inches high, or other user specified size) to adapt the change of the page of the processing image 20. Although such design can facilitate the operations for users, yet the objects including the frame 13, figure 11 and text 12 on the image mask 10 may have the phenomena including distortions or deformation, uncoordinated designs and position shifts due to a change of dimensions of the page of the image 20, and thus the original meticulous design that meets the artistic design of the image mask 10 will lose its originally intended design style and concept.

FIG. 1 shows a landscape image 20 having a specification of 5 inches wide and 3 inches high. If the original design of the image mask on the screen of the electronic device provided for users to click or select has the landscape design in the dimensions of 5″×3″, a composite image 30 as shown in FIG. 2 and formed by combining the image mask and the image fits the original designer's expected artistic visual effect and design style naturally. However, if a user applies the same image mask to a portrait image 40 with a specification of 4 inches wide and 6 inches high as shown in FIG. 3, the application software will automatically change the original image mask according to the page size of the image 40 to produce a portrait image mask 50 with the 4″×6″ specification as shown in FIG. 3 in order to adapt the change of page of the image 40. Now, the objects including a figure 51, a text 52 and a frame 53 contained in the image mask 50 will have an abnormal phenomenon such as a distortion or a deformation, an uncoordinated design and a position shift of the object, and thus the final composed image will be very much different from the designer's originally expected design style and artistic visual effect.

### SUMMARY OF THE INVENTION

In view of the foregoing shortcomings of the prior art, the inventor of the present invention based on years of experience in the related industry to conduct extensive researches and experiments to improve the object on the aforementioned image mask to adapt the change of the image page and overcome the issues of distortion and deformation, uncoordinated design and position shift, and finally invented a method for automatically adjusting the position and size of each object of an image mask to fit an image page in accordance with the present invention.

Therefore, it is a primary object of the present invention to provide a method for automatically adjusting the position and size of each object of an image mask to fit an image page, and the method is applied to an image mask. The image mask includes an object such as a frame, a figure and a text, and each object can change its position and dimensions on the image mask according to a predetermined variable or invariable attribute and a relative position attribute or absolute position attribute to automatically adjust its position and dimensions on the image mask to adapt the change of the image page, such that after the image mask is adjusted, the position and dimensions of each object still can meet the designer's expected design style and artistic visual effect.

Another objective of the present invention is to provide a frame object of the image mask that is set with a variable attribute and a relative position attribute or an absolute position attribute for automatically adjusting the corresponding dimensions and relative position or absolute position on the image mask according to the change of aspect ratio of the image page, such that after the image mask is adjusted, the hollow window of the frame object changes as the aspect ratio of the image page changes, and its edges remain attached onto the edges of the image page.

Another objective of the present invention is to provide a figure object of the image mask that is set with an invariable attribute and an absolute position attribute for automatically and proportionally adjusting the width or height of the figure object according to the dimensional change of the width or height of the image page, such that a specific distance is maintained between the figure object and a standard reference point of the image page. After the image mask is adjusted, the figure object will not be distorted or deformed, and the figure object is still fixed at the corresponding design position.

A further objective of the present invention is to provide a text object of the image mask that can be set to an invariable attribute and a relative position or an absolute position for automatically and proportionally adjusting the dimensions of text object according to the dimensional change of width or height of the image page text object and adjusting the relative position or absolute position of the text object on the image mask, such that after the image mask is adjusted, the text object will not be distorted or deformed, and the text object will be still fixed at the matching coordinated design position.

The above and other objects, features and advantages of the present invention will become apparent from the following detailed description taken with the accompanying drawings.

### BRIEF DESCRIPTION OF THE DRAWINGS

FIG. 1 is a schematic view showing the relation between an image mask and a desired processing image in a conventional electronic device;

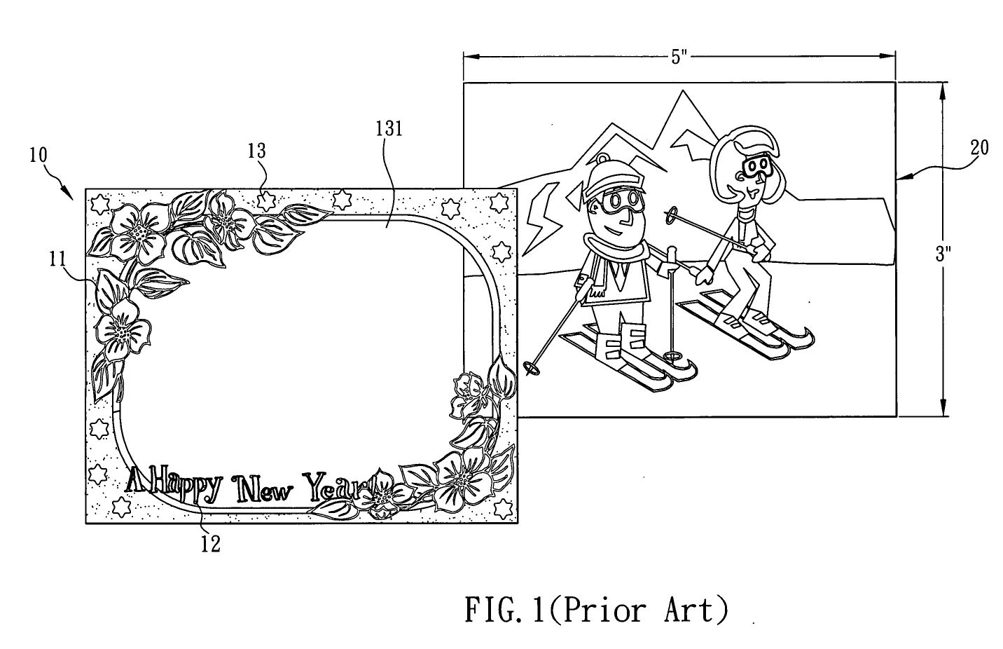

FIG. 2 is a schematic view showing a composed image of an image mask and an image page in a conventional electronic device;

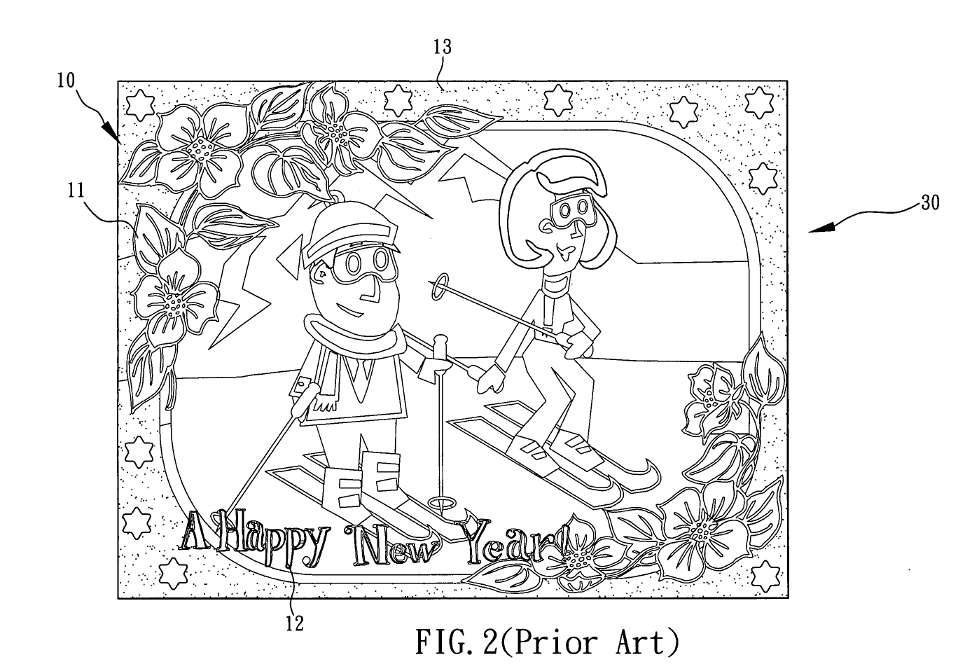

FIG. 3 is a schematic view showing the relation between the dimensions of an image page of a desired processing conventional image mask as depicted in FIG. 1 after automatically adjusting its position and dimensions of another image page;

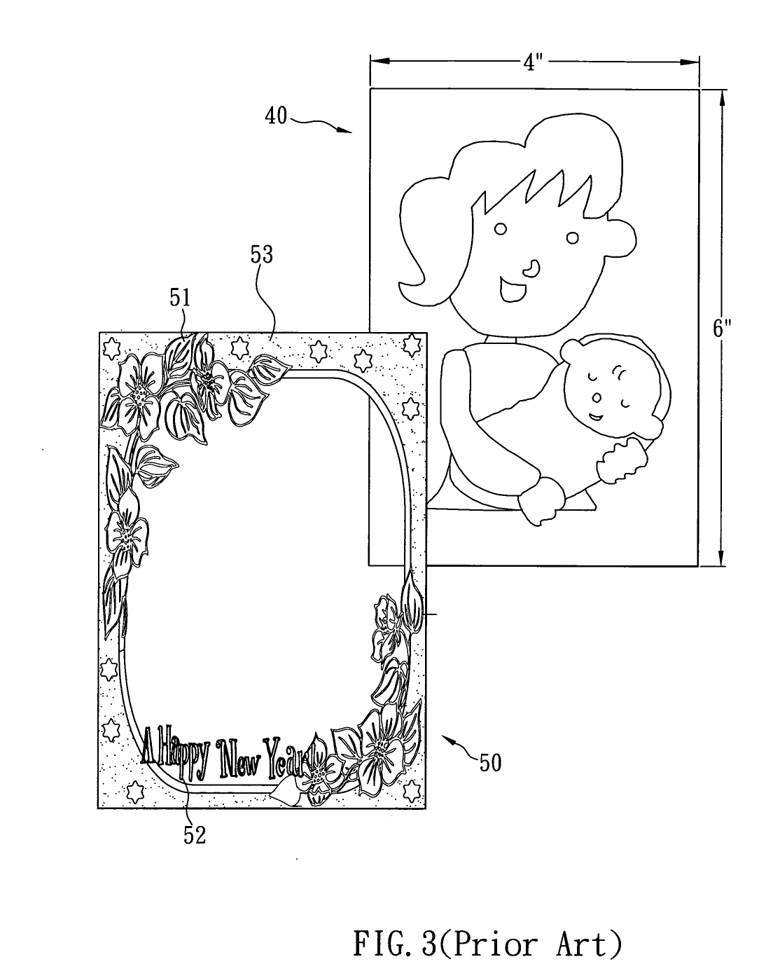

FIG. 4 is a schematic view showing the relation between the position and dimensions of any object on an image mask and the dimensions of the image mask according to the present invention;

FIG. 5 is a schematic view of a composed image of an image mask and an image page according to a preferred embodiment of the present invention; and

FIG. 6 is a schematic view of a composed image of an image mask as depicted in FIG. 5 and another image page with different dimensions according to the present invention.

### DETAILED DESCRIPTION OF THE PREFERRED EMBODIMENTS

In general, when a professional designer designs and produces an image mask, any image mask created according to a design subject matter or direction such as a romantic design, a perceptual design, a passionate design, or a design with the subject of culture and festival comprises three objects: a frame, a figure and a text. The frame object is a frame having a hollow window for covering the less important scenery at the edge of the processing image, such that the important main body of the processing image can be exposed from the hollow window. With the decoration of the frame object, the subject of the design can be shown, and thus many choices are available for the material of the frame and the shape of the hollow window to meet the requirements of different design subjects. The figure object is provided for decorating the figure of the frame object, and the figure object could be a pattern such as a flower, a bird, an animal, a zodiac sign or a symbol. The text object is used for describing or expressing the meaning of the image mask, and the text object could be a blessing, a seasonal greeting or a poem. Therefore, if a user clicks an image mask on the screen of an electronic device to attach the image mask to a processing image, the image mask will be merged with the processing image to produce a composed image in compliance with the user's requirements.

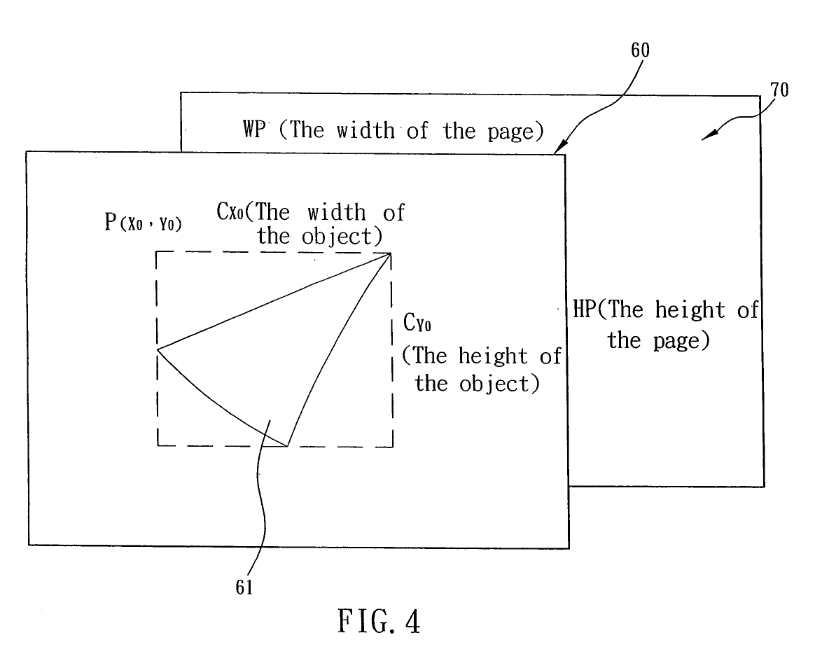

In FIG. 4, the position and size of the object 61 such as the frame, figure or text are designed meticulously and laid out on a template 60 to form a mask according to the design subject or direction by a professional designer. Therefore it is ideal to create a stylish design with the expected result and artistic visual effect regardless of the change of dimensions of the image mask. Based on this concept, when the dimensions of the processing image page 70 are changed, each object 61 must be able to be adjusted automatically according to the variable or invariable attribute and the relative position attribute or absolute position attribute for automatically adjusting the position and dimensions of the object 61 on the template 60 to fit the dimensions of the processing image page 70. After the image mask is adjusted, the position and dimensions of each object 61 on the image mask still can comply with the designer's expected artistic visual effect. Thus, the relation of the following function exists between the position and dimensions of the object 61 of the image mask and the dimensions of the image page 70:

xo=a1*Wp+b1*Hp

yo=c1*Wp+d1*Hp

Cxo=a2*Wp+b2*Hp

Cyo=c2*Wp+d2*Hp

where, xo is the x-coordinate of an end point of an object 61 disposed within the range of the screen display; yo is the y-coordinate of an end point of the object 61 disposed within the range of the screen display; Wp is the width of the template 60 (which is also the width of the processing image page 70); Hp is the height of the template 60 (which is also the height of the processing image page 70); Cxo is the width of the display range of the object 61; Cyo is the height of the display range of the object 61; and a1, b1, c1, d1, a2, b2, c2 and d2 are parameters for the layout design of the object 61 on the template 60.

Based on the foregoing concept of the invention, the invention divides the object 61 of the image mask into the following attributes according to the meanings and features of the object 61:

(1) Variable Attribute: The variable attribute is also known as a unidirectional stretch attribute. When the object 61 adjusts its dimensions according to the change of dimensions of the image page 70, the deformation of the object 61 will not adversely affect the artistic visual effect of the image mask, and thus a deformation of the object 61 is allowed. In the aforementioned object, the frame object used for covering the less important scenery of the processing image 70 comes with such variable attribute.

(2) Invariable Attribute: The invariable attribute is also known as a proportional zooming attribute. As the object 61 varies as the dimensions of the image page 70, the change of the shape of the object 61 adversely affects the artistic visual effect of the image mask when its dimensions are changed, and thus the deformation of an object 61 should be prevented. In the foregoing objects, the figure object used for decorating the frame is often a physical object in the pattern of a flower, a bird, an animal or a horoscope sign, and thus its aspect ratio should meet the requirements and proportion for a natural artistic design, and the text object for expressing the meaning of the image mask comes with an aspect ratio that can meet a certain standard proportion. From the designer's viewpoints, the aspect ratios of both figure object and text object should be able to prohibit any deformation.

(3) Relative Position Attribute: As the object 61 varies with the dimensions of the image page 70 and adjusts its relative position on the template 60, the artistic visual effect of the image mask will not be affected adversely, and thus the object 61 can be fixed at the relative position. In the foregoing objects, the frame object is used for covering the less important scenery at the edge of the processing image 70, such that when the dimensions of the image page 70 are changed to adjust its relative position on the template 60, the artistic visual effect of the image mask will not be affected adversely. Further, the text object is used for expressing the meaning of the image mask and generally designed according to a specific ratio (with half of the page for its width and one-third of the page for its height) on the image mask. As the image page 70 varies, the relative position on the template 60 is changed, and thus the artistic visual effect of the image mask will not be affected adversely.

(4) Absolute Position Attribute: As the dimensions of the image page 70 vary, the artistic visual effect of the image mask will be affected adversely If the distance between an object 61 and a certain standard reference point (such as an upper left corner, an upper right corner, an upper boundary, a lower boundary, a longitudinal center line or a transversal center line) of the image page 70 remains unchanged. Therefore, the distance between the object 61 and a certain standard reference point of the image page 70 is allowed to be maintained constant. In the foregoing object, the figure object is provided for decorating the frame object, and thus the distance between its position and a certain standard reference point of the image page 70 should be maintained constant, so as maximize the effect of decorating the frame object.

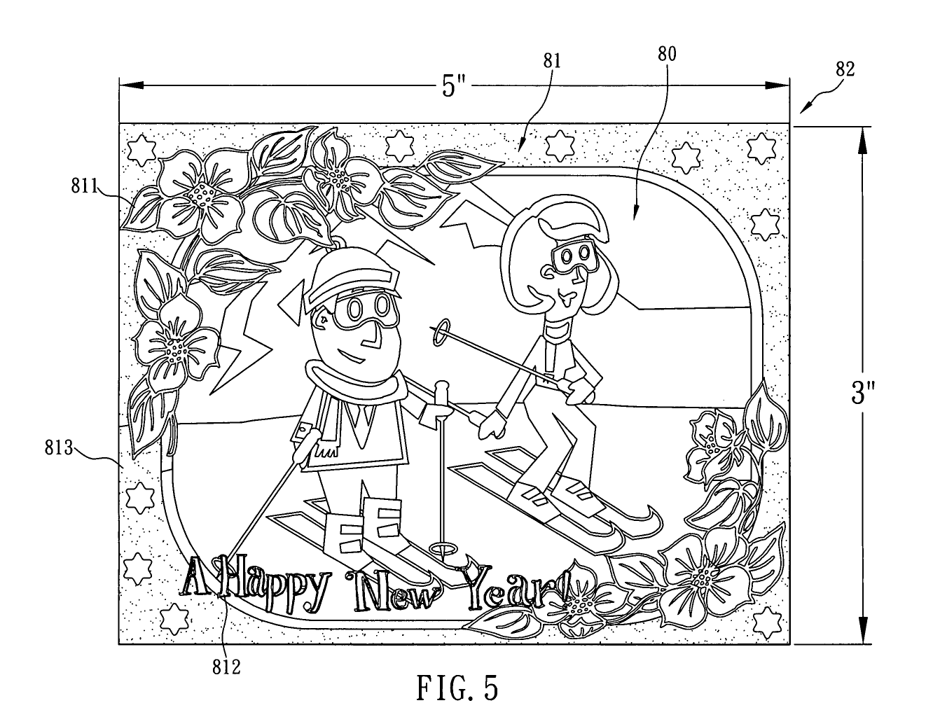

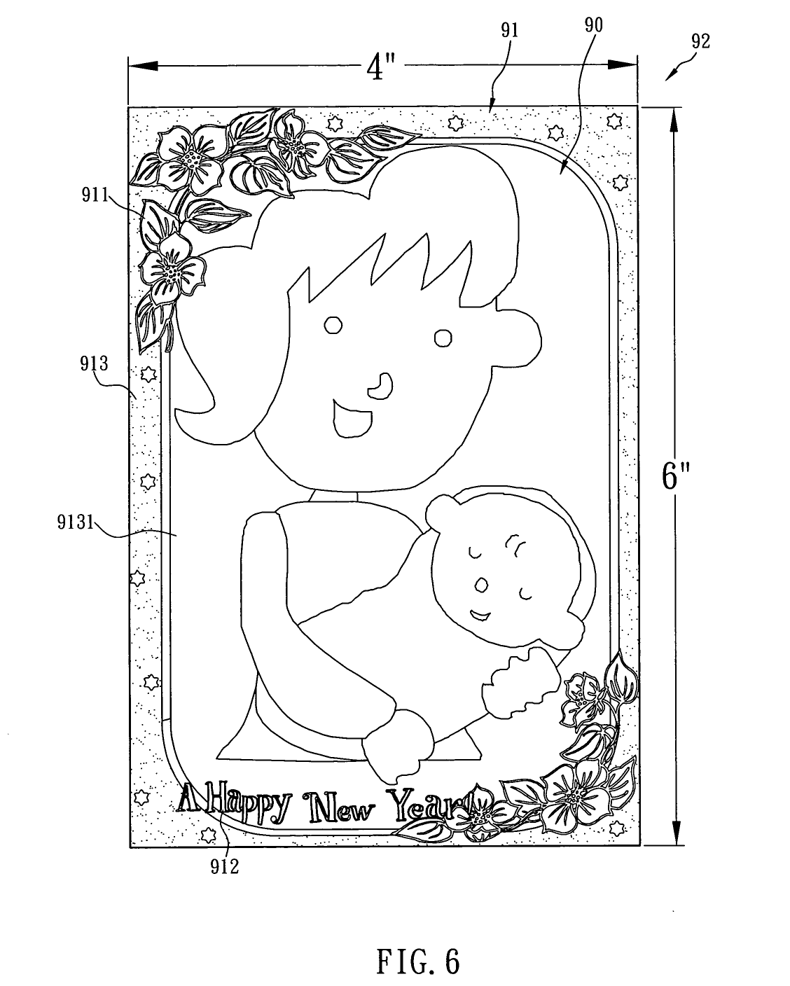

In the method for automatically adjusting the position and size of each object of an image mask to fit an image page of the present invention, designers can set the attributes for the frame, figure and text of the object 61 in advance according to the attributes of the foregoing object. In other words, each object 61 in the above formula arranges the design parameters a1, b1, c1, d1, a2, b2, c2, d2 on the template 60, so that when the size of the processing image page 70 is changed, the position and dimensions of the object 61 can be adjusted, and the adjusted position and dimensions still can meet the requirements of an artistic visual effect. In the specification of a preferred embodiment of the present invention as shown in FIG. 5, a landscape image 80 has dimensions of 5″×3″. A user can click the image mask 81 on the screen of an electronic device, and the original dimensions are also 5″×3″ for a landscape design, and the landscape image 80 and the landscape design can be combined into a composed image 82 as shown in FIG. 5, the composed image 82 naturally shows the designer's expected artistic visual effect and design style. If a users applies the same image mask to a 4″×6″ portrait image 90 as shown in FIG. 6, the application software will automatically change the size of the image mask according to the page size of the image 90 to produce a 4″×6″ portrait image mask 91 as shown in FIG. 6 to adapt the change of the page of the image 90. By then, the image mask 91 includes the following objects such as a figure 911, a text 912 and a frame 913, and the position and dimensions are adjusted according to the set attributes:

(1) Frame Object 913: The relative position and dimensions of the image mask 91 can be adjusted according to the preset variable and relative position attributes and the change of aspect ratio of the image page 90 to fit the page size of the processing image 90, such that after the image mask 91 is adjusted, the size of hollow window 9131 of the frame object will change according to the change of width or height of the image 90, and its edges are aligned even with the edges of the page of the processing image 90.

(2) Figure Object 911: The dimension (width or height) of the figure object 911 can be adjusted proportionally according to the preset variable and absolute position attributes and the change of the dimension (width or height) of the page of the image 90 is changed automatically, such that the distance between the figure object 911 and a certain standard reference point (such as the upper left corner and the lower right corner) of the page of the image 90 is maintained constant. After the image mask 91 is adjusted, the figure object 911 will not be distorted and deformed, and the figure object 911 will be fixed at the corresponding absolute position.

(3) Text Object 912: The dimensions of the text object 912 can be adjusted proportionally according to a preset variable and absolute position attribute and the change of the dimension (width or height) of the image 90, and a specific distance between the text object 912 and a certain standard reference point (such as a longitudinal center line) of the image 90 is maintained, such that after the image mask 91 is adjusted, the text object 912 will not be distorted and deformed, and the text object 912 will be fixed at the corresponding matched and coordinated position.

After the attributes for the position and size of an object such as a frame 913, a figure 911 or a text 912 as shown in FIG. 6 are set and rearranged on the image mask 91, the artistic visual effect of the objects such as the frame 813, figure 811 and text 812 as shown in FIG. 5 on the image mask 81 can meet the designer's expected result, and the object will not have the distortion or deformation, uncoordinated sign or position shift.

While the invention herein disclosed has been described by means of specific embodiments, numerous modifications and variations could be made thereto by those skilled in the art without departing from the scope and spirit of the invention set forth in the claims.

What is claimed is:

1. A method for automatically adjusting the position and size of each object of an image mask to fit an image page, applied to an application software, and said application software providing at least one image mask, and said image mask including a plurality of objects, and said method comprising:
presetting a variable attribute or an invariable attribute and a relative position attribute or an absolute position attribute for each object, such that when said variable attribute adjusts the dimensions of said each object according to the size of said image page, the shape of said object is permitted to be changed; and when said invariable attribute adjusts the dimensions of said each object according to the size of said image page, the shape of said object is not permitted to be changed; and when said relative position attribute adjusts the position of said each object according to the size of said image page, said object is permitted to be fixed at a relative position; and when said absolute position attribute adjusts the position of said each object according to the size of said image page, a predetermined distance is maintained between said object and a standard reference point of said image page; and
attaching said image mask to a processing image page, and setting said each object to predetermined attributes if the size of said image mask is different from the size of said processing image page, so as to automatically adjust the position and dimensions of said image mask to fit the size of said processing image page and merge with said processing image page to produce a composed image.

2. The method of claim 1, wherein said object includes a frame object, and said frame object is a frame having a hollow window for covering an unimportant scenery at edges of a desired processing image, such that a main body of said processing image can be exposed from said hollow window.

3. The method of claim 2, wherein said frame object is set with a variable attribute and a relative position attribute, such that the relative position and dimensions of said image mask can be adjusted automatically according to the change of aspect ratio of said image page.

4. The method of claim 3, wherein said object further includes a figure object, and said figure object is an object for decorating said frame object.

5. The method of claim 4, wherein said figure object is set with an invariable attribute and an absolute position attribute, such that the dimensions of said figure object can be adjusted proportionally according to a dimensional change of the width or height of said image page, and a predetermined distance is maintained between said figure object and a standard reference point of said image page.

6. The method of claims 3, wherein said object further includes a text object for describing or expressing the meaning of said image mask.

7. The method of claims 5, wherein said object further includes a text object for describing or expressing the meaning of said image mask.

8. The method of claim 6, wherein said text object is set with an invariable attribute and a relative position attribute, such that the dimensions of said text object can be changed proportionally according to the width or height of said image page, and the relative position of said text object with respect to said image mask is adjusted.

9. The method of claim 7, wherein said text object is set with an invariable attribute and a relative position attribute, such that the dimensions of said text object can be changed proportionally according to the width or height of said image page, and the relative position of said text object with respect to said image mask is adjusted.

10. The method of claim 6, wherein said text object is set with an invariable attribute and an absolute position attribute, such that the dimensions of said text object can be changed proportionally according to the width or height of said image page, and a predetermined distance is maintained between said figure object and a standard reference point of said image page.

11. The method of claim 7, wherein said text object is set with an invariable attribute and an absolute position attribute, such that the dimensions of said text object can be changed proportionally according to the width or height of said image page, and a predetermined distance is maintained between said figure object and a standard reference point of said image page.
